(19) United States
(12) Patent Application Publication
(10) Pub. No.: US 2004/0201785 A1
(43) Pub. Date: Oct. 14, 2004

(54) CRT support panel

(75) Inventor: David Xu, Cerritos, CA (US)

Correspondence Address: ORRICK, HERRINGTON & SUTCLIFFE, LLP, 4 PARK PLAZA, SUITE 1600, IRVINE, CA, 92614-2558, US

(73) Assignee: MITSUBISHI DIGITAL ELECTRONICS, INC.

(21) Appl. No.: 10/412,031

(22) Filed: Apr. 10, 2003

(51) Int. Cl. H04N 5/64

(52) U.S. Cl. 348/787; 348/789

(57) ABSTRACT

A CRT support panel for a projection television set is provided that includes a generally vertically extending body, a mounting foot extending from the base of the body and a handle extending from the top of the body. The body preferably has a thin walled open corrugated profile. The corrugated profile enables the cross-section of the panel to be increased to significantly increase it strength to guard against buckling without significantly increasing its weight. The panel, which is preferably plastic injection molded as a unitary part, tends to have sufficient flexibility to guard against shock and vibration damage during transportation.

### FIELD OF THE INVENTION

The present invention relates generally to projection television sets, and more particularly to inner side CRT support panels that elevate the optical unit brackets off of the base of the projection television sets.

### BACKGROUND OF THE INVENTION

Projection television sets are a popular alternative to picture tube television sets, as they provide relatively large viewable screens that cannot be efficiently produced using conventional picture tubes. Projection television sets typically include an enclosure with an optical unit, a mirror, and electronic components for receiving and projecting an image onto a screen assembly mounted on the front of the enclosure.

A current, typical projection television set 100 is shown in FIGS. 1A-1B. Turning to FIG. 1A, the components of the projection television set 100 are illustrated. The projection television set 100 has an optical unit 10 that generally includes a set of projection units 20R, 20G, and 20B. Each projection unit projects an image, generally of a single color of light (red, green, or blue), onto the mirror M in the enclosure (not shown), which focuses the image onto an inside surface of the screen S. Each projection unit 20R, 20G, 20B includes a cathode ray tube (CRT) 22R, 22G, 22B, a projection lens assembly 45R, 45G, 45B, and a spacer 28R, 28G, 28B interposed between each respective CRT and projection lens assembly. The projection units 20R, 20G, 20B are typically mounted to a metal CRT bracket 50.

FIG. 1B shows a side cut-away view of a current projection television set 100 having an enclosure or cabinet 105 to contain the components previously described. The enclosure 105 is typically divided by an internal wall 112 into two compartments, an upper compartment 114 and a lower compartment 116. The internal wall 112 tightly seals the upper compartment 114 from the lower compartment 116 to protect the inside of the upper compartment 114 from dust and other foreign materials. The optical unit 10 is typically mounted in the lower compartment 116, while the mirror M and screen S are mounted in the upper compartment 112. Furthermore, the optical unit 10 typically extends from the lower compartment 116 into the upper compartment through the internal wall 112. The lower compartment 116 generally includes one or more sets of ventilation holes 118 to exhaust heat radiating from the optical unit 10 and any other components, such as, e.g., printed wiring boards (not shown) that may be located in the lower compartment 116.

The CRT bracket 50 is elevated off the base of the cabinet typically through the use of vertical inner side panels. There is one panel on each side of the metal CRT bracket 50 inside of the television enclosure or cabinet 105. Traditionally, these side panels were made of wood, which has its drawbacks. For example, relative to plastic, wood panels are heavy and tend to lack sufficient flexibility to cushion the CRTs during transportation to prevent damage shock and vibration. However, due to the combined weight of the CRTs, solid plastic panels sized to fit within the enclosure tend not to have sufficient strenght to support the CRT bracket.

Therefore, it would be desirable to provide lighter, more flexible inner side panels to support the CRT bracket and guard against shock damage during transport.

### SUMMARY OF THE INVENTION

The present invention is directed to improved inner side panels for elevation and support of CRT brackets in projection television set enclosures. A pair of panels is preferably coupled to the chassis and a CRT bracket of a television set to elevate and support the CRTs and bracket assembly off of the base of the television set. In a preferred embodiment, the support panel is preferably plastic injection molded as a unitary part. The panel includes a generally vertically extending body, an mounting foot extending from the base of the body and a handle extending from the top of the body. The body preferably has a thin walled corrugated profile comprising alternating open hollow columns. The corrugated profile enables the cross-section of the panel to be increased to significantly increase the strength of the panel to guard against buckling without significantly increasing its weight. Because the panel is preferably formed of plastic, it can be made flexible enough to guard against damage due to shock and vibration during transportation.

In an alternative embodiment, the panel or sections thereof may be formed from extruded plastic having a closed square, rectangular or triangular thin walled tubular or hollow column profile. Like the open corrugated profile, the cross-section of the panel can be increased to significantly increase the strength of the panel without significantly increasing the weight of the panel.

Other objects and features of the present invention will become apparent from consideration of the following description taken in conjunction with the accompanying drawings.

### DESCRIPTION OF THE DRAWINGS

FIG. 1A illustrates a schematic representation of the components of a current, typical projection television set.

FIG. 1B is a side view of a current, typical projection television set showing an enclosure of the set with the components therein.

FIG. 2 is an oblique view of a CRT support panel of the present invention.

FIG. 3 is a back view of the support panel shown in FIG. 2.

FIG. 4 is an oblique view of a pair of support panels of the present invention coupled to the chassis of a television set and supporting a CRT and bracket assembly.

FIG. 5 is a front view of the support panels, chassis and CRT bracket assembly shown in FIG. 4.

FIG. 6 is a side view of the support panels, chassis and CRT bracket assembly shown in FIG. 4.

FIGS. 7A, 7B and 7C are cross-sectional views of exemplary embodiments of the corrugated body of the support panel of the present invention take along line 7-7 in FIG. 2.

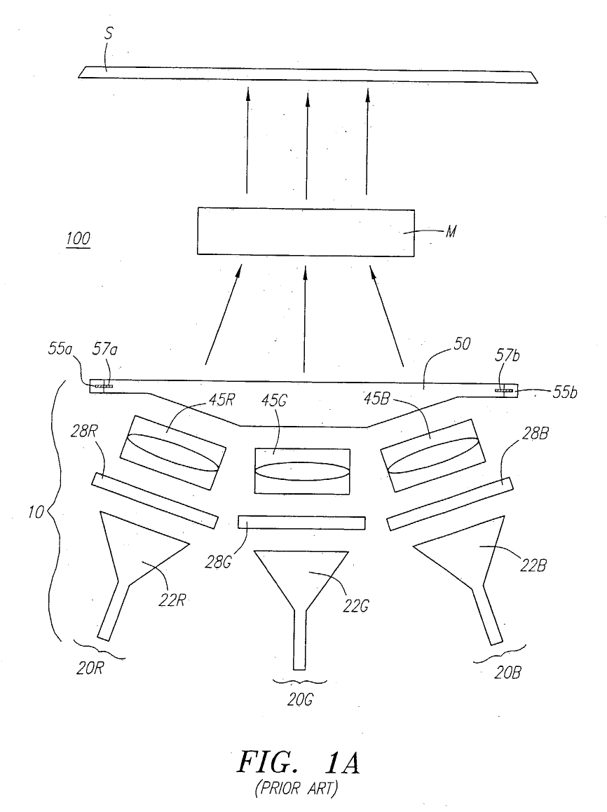

### DETAILED DESCRIPTION

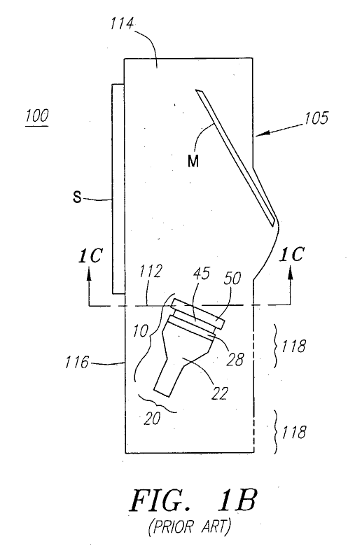

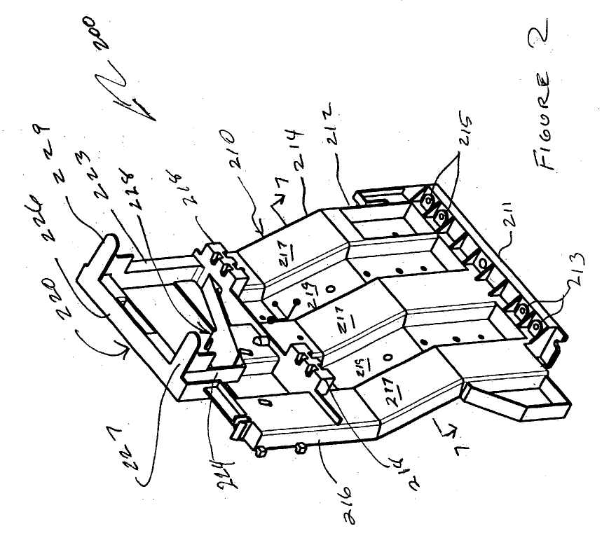

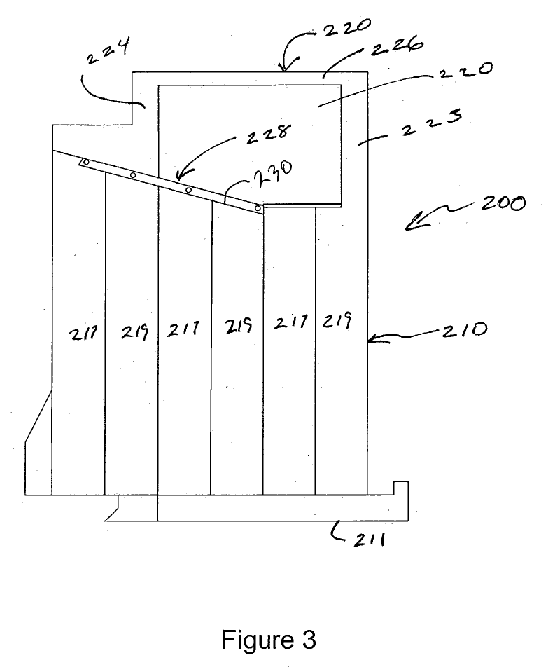

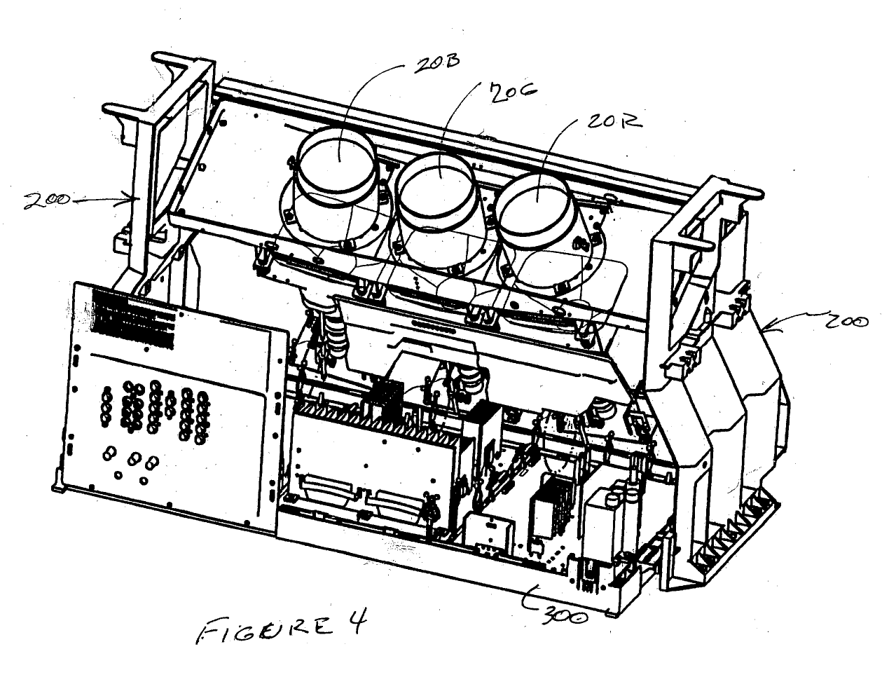

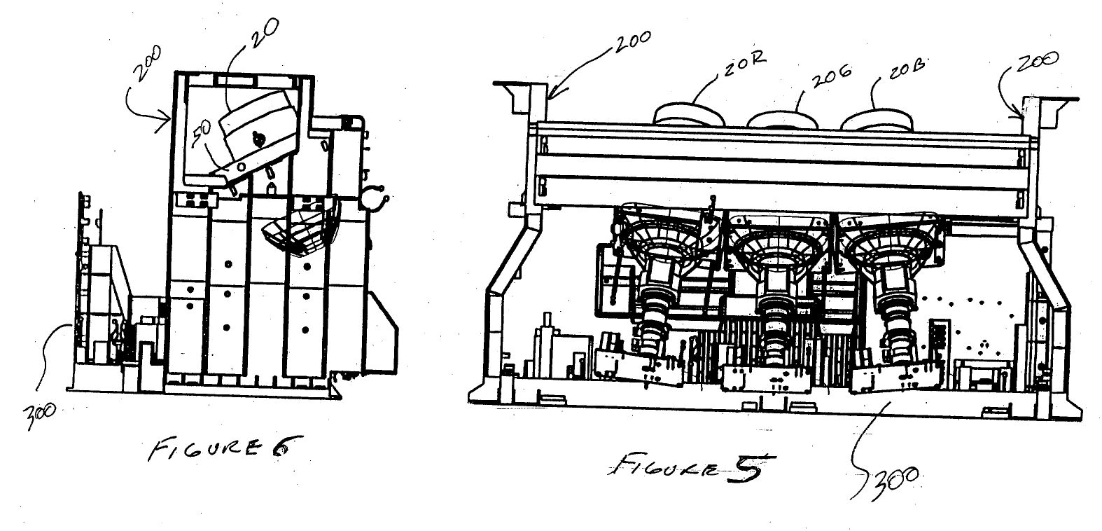

As shown in detail in FIGS. 2 through 7, the present invention is directed to an improved inner side or CRT support panel used to elevate and support the CRT and bracket assembly of a projection television set off of the base of the projection television set. FIGS. 2 and 3 provide oblique and back views of a CRT support panel 200 constructed in accordance with a preferred embodiment of the present invention. As depicted in FIGS. 4-6, a pair of such panels 200 is shown preferably coupled to a chassis 300 and a CRT bracket 50 of a television set to elevate and support the CRTs 20R, 20G and 20B and bracket 50 assembly off of the base of the television set.

Turning to FIGS. 2 and 3, the support panel 200, in accordance with a preferred embodiment, advantageously comprises a plastic injection molded panel of unitary construction, which substantially reduces the number of parts necessary to elevate and support the CRT 20 and bracket 50 assembly of a projection television and, thus, significantly simplifies the assembly process of a projection television set using the panels 200 of the present invention. As depicted, the panel 200 preferably includes a generally vertically extending body 210, an integrally formed mounting foot 211 laterally extending from the base of the body 210 and an integrally formed handle 220 extending from the top of the body 210 generally in the same plane as the body. The mounting foot 211 extends substantially the width of the body 210 and, as depicted, includes two (2) sets of mounting holes 213 and 215 to fix the panel 200 to the base of a television set.

The body 210 may be formed of a single continuous section or integrally formed multiple sections to accommodate differing television enclosure internal profiles. As depicted in FIG. 2, a preferred embodiment of the body 210 includes a generally vertically extending lower section 212, a generally vertically and inwardly extending midsection 214 and a generally vertically extending upper section 216. Each section of the body 210 preferably comprises a corrugated profile comprising integrally formed alternating open hollow columns 217 and 219. The open hollow columns 217 and 219 forming the corrugated profile extend vertically generally parallel to a longitudinal axis of the body 210 of the panel 200. Thus, the compression load exerted on the panels 200 once the panels 200 are part of the completed assembly, is exerted along or generally parallel to the longitudinal axis of each column 217 and 219.

The handle 220, which extends generally vertically from the body 210 above the board-shelf mounts 218 and adjacent the handle transition region 228, includes generally vertically extending handle supports 223 and 224 and a cross-member 226 extending generally horizontally between the supports 223 and 224 to enclose an opening 222. During assembly, the handles enables the assembler to easily carry or transport the individual panels 200 or the assembled panel 200, bracket 50, CRTs 20 and chassis 300 assembly. The cross-member 226 is preferably flat on top and includes a pair of mounting fingers 227 and 228 extending outwardly from the cross-member 226. When assembled as shown in FIGS. 4-6, the cross-member 226 and fingers 227 and 229 of each panel 200 mate with the preferably flat surface of the base of the body 210 and mounting foot 211 to enable the completed assemblies to be easily stacked for later use during assembly of the television set.

As shown in FIG. 3, the handle transition region 228 preferably includes a mounting flange 230 for coupling the CRT bracket 50 to the panels 200. The mounting flange is preferably oriented at a predetermined angle to enable light emitted from the CRTs 20 to be projected at a predetermined angle within the enclosure 105 of the television set.

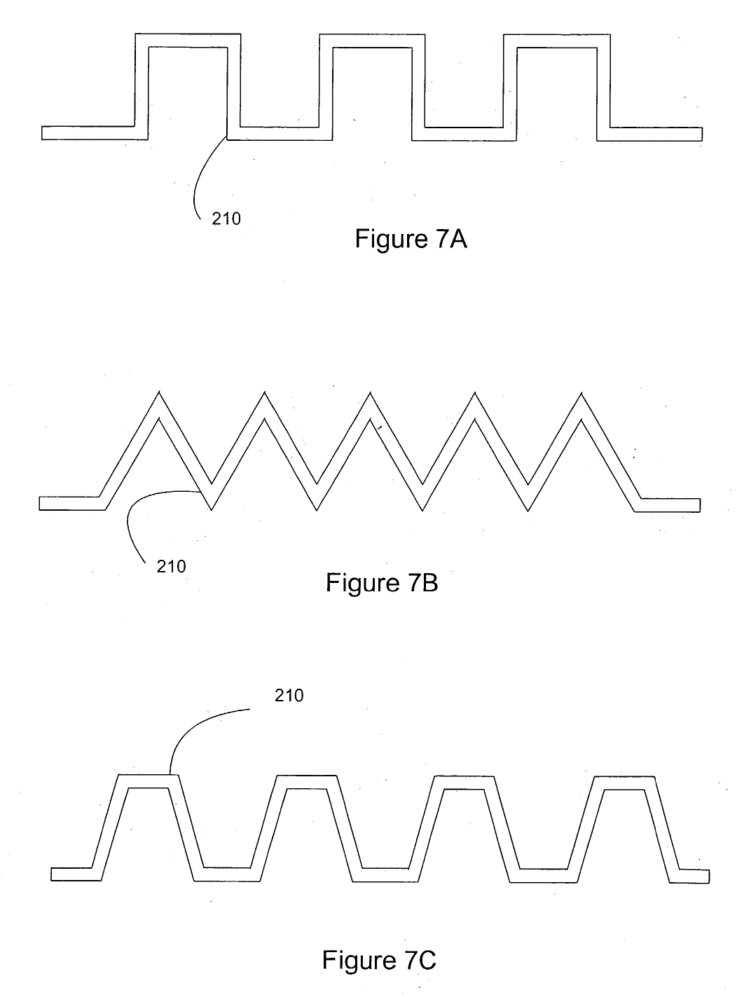

As noted above, the cross-sections of the lower, mid and upper sections 212, 214 and 216 of the body 210 of the panel 200 comprise a thin walled (about three (3) millimeter) open corrugated profile. Turning to FIGS. 7A, 7B and 7C, exemplary corrugated panel profiles preferably include the shape of a square wave (FIG. 7A), a triangular wave (FIG. 7B), a truncated triangular wave (FIG. 7C) and the like. By manufacturing the panel 200 with an open corrugated profile, the panel can be of unitary construction and the cross-section of the panel 200 can be increased significantly without increasing the weight of the panel 200. With an increased cross-section, the panel 200 has sufficient strength to support the CRTs 20 and bracket 50 assembly and guard against buckling. Because it is formed of plastic, the panel 200 tends to be sufficiently flexible to guard against shock damage during shipping of the television.

In the alternative, sections of the panel 200 may be formed from extruded plastic and coupled together. As such, instead of open corrugated type profiles, closed square, rectangular and triangular profiles may be formed providing a thin walled tubular or hollow column profile.

The particular examples set forth herein are instructional and should not be interpreted as limitations on the applications to which those of ordinary skill are able to apply this device. Modifications and other uses are available to those skilled in the art which are encompassed within the spirit of the invention as defined by the scope of the following claims.

What is claimed is:

1. A projection television set comprising:
a bracket having first and second ends,
a plurality of projection units coupled to the bracket, and
first and second vertically extending panels coupled to the first and second ends of the bracket, the first and second panels having a corrugated profile.

2. The projection television set of claim 1 wherein the corrugate profile is in the shape of a square wave.

3. The projection television set of claim 1 wherein the corrugate profile is in the shape of a triangular wave.

4. The projection television set of claim 1 wherein the corrugate profile is in the shape of a truncated triangular wave.

5. The projection television set of claim 1 wherein the corrugate profile is formed from a thin wall of plastic.

6. The projection television set of claim 5 wherein the thin wall of plastic is about 3 mm thick.

7. The projection television set of claim 1 wherein the first and second panels are plastic injection molded.

8. The projection television set of claim 1 wherein the first and second panels are formed of unitary construction.

9. The projection television set of claim 1 wherein the first and second panels include a body and an integrally formed handle.

10. The projection television set of claim 1 wherein the first and second panels include a mounting flange for mounting the bracket at a predetermined angle.

11. The projection television set of claim 10 wherein the body includes a lower section, a middle section and an upper section.

12. A panel for supporting a CRT and bracket assembly of a projection television comprising
a generally vertically extending body having a corrugated profile,
a mounting foot extending from the base of the body, and
a handle extending from the top of the body.

13. The projection television set of claim 12 wherein the corrugate profile is in the shape of a square wave.

14. The projection television set of claim 12 wherein the corrugate profile is in the shape of a triangular wave.

15. The projection television set of claim 12 wherein the corrugate profile is in the shape of a truncated triangular wave.

16. The projection television set of claim 12 wherein the corrugate profile is formed from a thin wall of plastic.

17. The projection television set of claim 12 wherein the thin wall of plastic is about 3 mm thick.

18. The projection television set of claim 12 wherein the panel is plastic injection molded.

19. The projection television set of claim 12 wherein the body and handle are integrally formed.

20. The projection television set of claim 12 wherein the panel include a mounting flange for mounting a CRT bracket at a predetermined angle.

21. The projection television set of claim 12 wherein the body includes a lower section, a middle section and an upper section.
